(19) United States
(12) Patent Application Publication
(10) Pub. No.: US 2025/0088003 A1
(43) Pub. Date: Mar. 13, 2025

(54) SYNERGISTIC SYSTEM

(71) Applicant: Intellihot, Inc., Galesburg, IL (US)

(72) Inventors: Sridhar Deivasigamani, Mundelein, IL (US); Sivaprasad Akasam, Round Rock, TX (US)

(21) Appl. No.: 18/957,828

(22) Filed: Nov. 24, 2024

Related U.S. Application Data
(63) Continuation-in-part of application No. 17/532,255, filed on Nov. 22, 2021.
(63) Continuation-in-part of application No. 17/012,346, filed on Sep. 4, 2020, now Pat. No. 11,662,127.

(51) Int. Cl. H02J 3/32; F24D 17/00; F24F 11/46; F24H 7/00; F24H 15/164; F24H 15/168; F24H 15/172; H01M 6/36; H01M 10/613; H01M 10/615; H01M 10/627; H02J 7/00; H02J 7/34

(52) U.S. Cl. CPC H02J 3/32; F24D 17/0036; F24F 11/46; F24H 7/002; H01M 6/36; H01M 10/613; H01M 10/615; H01M 10/627; H02J 7/0063; H02J 7/0068; H02J 7/34; F24F 2203/021; F24F 2221/34; F24F 2221/54; F24H 15/164; F24H 15/168; F24H 15/172; H01M 2220/10

(57) ABSTRACT

A method for controlling a system including a heat pump, a space heater, a space cooler, a thermal battery, an electrical battery and a grid access system, the method including turning on at least one of discharging of the thermal battery and discharging of the electric battery, if a hot water demand exists; turning on at least one of the heat pump, charging of the thermal battery, charging of the electric battery and discharging of the electric battery, if a space heating demand exists; turning on charging of the thermal battery, if a space cooling demand exists; and backfeeding electricity from the electric battery to a grid through the grid access system, if electricity sale is desired.

### PRIORITY CLAIM AND RELATED APPLICATIONS

This continuation-in-part application claims the benefit of priority from non-provisional application Ser. No. 17/532,255 filed on Nov. 22, 2021 which in turn claims the benefit of priority from non-provisional application Ser. No. 17/012,346 filed on Sep. 4, 2020. Each of said applications is incorporated by reference in its entirety.

### BACKGROUND OF THE INVENTION

### 1. The Field of the Invention

The present invention relates to an electric space heating, space cooling and water heating system. More specifically, the present invention is directed to an electric space heating, space cooling and water heating system including a heat pump and an energy storage device.

### 2. Background Art

Various fossil fuel phase-out initiatives have been made in the heating industry and mandates have been increasingly devised and implemented to phase out the direct or indirect use of fossil fuel in heat production for domestic and/or industrial uses. Attempts have been made to heat domestic water with alternative means, e.g., with the use of heat pumps having operations that are primarily driven using electricity in the form of pump or compressor operations. Supplemental electric heating elements may also be employed to aid fossil fuel-free domestic water heating systems in meeting heating demands. However, the need to meet heating demands has driven designers to return to tanked solutions which bring back the disadvantages associated with such solutions, one of the disadvantages being the exposure of stagnant domestic water disposed at temperature ranges suitable for Legionella proliferation when hot water demands are small, over extended periods. Two examples of tanked solutions are included herein where domestic hot water is supplied directly from a tank in each of these examples:

U.S. Pat. Pub. No. 20190128565 of Pugh et al. (hereinafter Pugh) discloses a heat pump water heater having a tank, a heat source and a heat pump system. The heat pump system has a refrigerant path, at least a portion of which is in thermal communication with the water tank volume such that heat transfers from a refrigerant to the water tank volume. A fan causes air to flow through a housing, and another portion of the refrigerant path includes an evaporator in the housing. The fan is within the housing and may further be within a second housing. The first housing may include a baffle to direct air flow. The fan may be a variable speed fan in communication with a controller, so that the controller controls the fan speed depending on a temperature of the refrigerant.

U.S. Pat. Pub. No. 20100209084 of Nelson et al. (hereinafter Nelson) discloses a heat pump water heater and systems and methods for its control. The systems are configured to heat water within a water storage tank of a heat pump water heater wherein a controller within the system is operatively connected to a plurality of heat sources including at least one electric heating element and a heat pump and sensors in order to selectively energize one of the plurality of heat sources. The controller is configured to process data representative of the temperature of water within the tank near the top of the water storage tank, and rate of water flowing out of the water storage tank, in order to automatically selectively energize the heat sources. The selection of heat sources by the controller is determined by a mode of operation selected by the user and the data processed by the controller in view of the selected mode of operation.

Each of Pugh and Nelson discloses the use of a large thermal storage tank that accommodates demands of hot water. As each of Pugh and Nelson's tanks holds a significant amount of water to anticipate demands, there is no guaranty that all portions of the heated water in the tank will exit the tank and be replaced with fresh cold or unheated water. If insufficiently used and the water held in the tank is not consumed or replaced over a long period of time, Legionella can proliferate and the next user/s can be exposed to a heightened level of Legionella risk.

There exists a need for a heating system or a heating and cooling system that is not reliant on fossil fuel-free and one which is not exposed to the same Legionella risks plaguing tanked domestic water heating systems.

### SUMMARY OF THE INVENTION

In accordance with the present invention, there is provided a method for controlling a system including a heat pump, a space heater, a space cooler, a thermal battery, an electrical battery and a grid access system, the method including:
(a) if a hot water demand exists, turning on at least one of discharging of the thermal battery and discharging of the electric battery;
(b) if a space heating demand exists, turning on at least one of the heat pump, charging of the thermal battery, charging of the electric battery and discharging of the electric battery;
(c) if a space cooling demand exists, turning on charging of the thermal battery; and (d) if electricity sale is desired, backfeeding electricity from the electric battery to a grid through the grid access system.

In one embodiment, the method further includes:
(e) if a hot water demand exists, further turning on at least one of the heat pump, charging of the thermal battery and charging of the electric battery;
(f) if a space heating demand exists, further turning on discharging of the thermal battery; and
(g) if a space cooling demand exists, further turning on at least one of the heat pump, charging of the electric battery and discharging of the electric battery.

In one embodiment, the step (e) includes charging of the thermal battery by turning on the heat pump. In one embodiment, the step (e) includes charging the electric battery if electricity purchase is desired. In one embodiment, the step (f) includes discharging the thermal battery to supplement the space heating demand. In one embodiment, the step (g) includes discharging the electric battery to drive the heat pump. In one embodiment, the step (g) includes charging the electric battery if electricity purchase is desired. In one embodiment, the step (a) includes discharging the electric battery to turn on the heat pump. In one embodiment, the step (a) includes discharging of the thermal battery to supplement the hot water demand. In one embodiment, the step (b) includes charging of the thermal battery by turning on the heat pump. In one embodiment, the step (b) includes discharging the electric battery to turn on the heat pump. In one embodiment, the step (b) includes charging the electric battery if electricity purchase is desired. In one embodiment, the step (c) includes charging of the thermal battery by turning on the heat pump.

An object of the present invention is to provide a heating system or a heating and cooling system that does not involve direct generation of hydrocarbons in powering the heating system or the heating and cooling system.

Another object of the present invention is to provide a heating system or a heating and cooling system capable of taking advantage of favorable pricing of the power, e.g., electric, that drives the system, to store heat energy or to evacuate heat energy to heat or cool at a later time, respectively.

Another object of the present invention is to provide a heating system or a heating and cooling system capable of storing heat energy for use at a later time.

Another object of the present invention is to provide a heating system or a heating and cooling system capable of providing a cold reservoir for use at a later time.

Another object of the present invention is to provide an electric storage device capable of storing electrical energy when it is favorable to have electrical energy stored in the electric storage device.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting a prior art electric domestic water heating system;

FIG. 2 is a diagram depicting a present electric domestic water heating system;

FIG. 3 is a diagram depicting the present electric domestic water heating system of FIG. 2 being used to provide a hot water supply;

FIG. 4 is a diagram depicting the present electric domestic water heating system of FIG. 2 being used to charge a thermal battery;

FIG. 5 is a diagram depicting the present electric domestic water heating system of FIG. 2 being used to provide a hot water supply;

FIG. 6 is a diagram depicting an electric domestic water heating, space heating and cooling system;

FIG. 7 is a diagram depicting the electric domestic water heating, space heating and cooling system of FIG. 6 being used to provide space heating;

FIG. 8 is a diagram depicting an electric domestic water heating, space heating and cooling system of FIG. 6 being used to provide space heating;

FIG. 9 is a diagram depicting an electric domestic water heating, space heating and cooling system of FIG. 6 being used to provide space cooling;

FIG. 10 is a diagram depicting an electric domestic water heating, space heating and cooling system of FIG. 6 being used to provide space cooling;

FIG. 10A is a diagram depicting an electric domestic water heating, space heating and cooling system of FIG. 6 being used to store heat energy;

FIG. 11 is a diagram depicting an electric domestic water heating, space heating and cooling system of FIG. 6 being used to provide a hot water supply;

FIG. 12 is a diagram depicting an electric domestic water heating, space heating and cooling system of FIG. 6 being used to provide a hot water supply;

FIG. 13 is a diagram depicting an electric domestic water heating, space heating and cooling system being used to provide a cold reservoir;

FIG. 14 is a diagram depicting one embodiment of a four-way two-position valve useful for reversing the flow of a flow loop where a valve spool is disposed in a first position;

FIG. 15 is a diagram depicting one embodiment of a four-way two-position valve useful for reversing the flow of a flow loop where a valve spool is disposed in a second position;

FIG. 16 is a diagram depicting one embodiment of 6-way two-position valve useful for switching a first flow loop for a second flow loop where a valve spool is disposed in a first position;

FIG. 17 is a diagram depicting one embodiment of 6-way two-position valve useful for switching a first flow loop for a second flow loop where a valve spool is disposed in a first position;

FIG. 18 is a diagram depicting possible operating modes of the devices shown in FIGS. 6-13;

FIG. 19 is a diagram depicting possible operating modes of the devices shown in FIGS. 6-13 when hot water is requested;

FIG. 20 is a diagram depicting possible operating modes of the devices shown in FIGS. 6-13 when space heating is requested;

FIG. 21 is a diagram depicting possible operating modes of the devices shown in FIGS. 6-13 when space cooling is requested;

FIG. 22 is a diagram depicting possible operating modes of the devices shown in FIGS. 6-13 when no hot water, space heating and space cooling are requested;

FIG. 23 is a block diagram representing distinct physical components of a synergistic system;

FIG. 24 is a block diagram representing a controller of the distinct components and the connectivity of the distinct components via the controller; and

FIG. 25 is a block diagram representing a controller of additional distinct components and the connectivity of the additional distinct components via the controller.

### PARTS LIST

2—electric heat pump
4—refrigerant loop
6—water loop
8—space heating or cooling loop
10—compressor
12—expansion valve
14—heat exchanger, e.g., evaporator, condenser
16—blower
18—first heat exchanger, e.g., plate type heat exchanger, condenser
20—thermal storage device
22—heat exchanger, e.g., bi-directional heat exchanger
24—fluid moving device, e.g., pump, e.g., variable speed pump
26—mixing valve, e.g., thermostatic mixing valve
28—cold water inlet
30—hot water outlet
32—supplementary heating element
34—pump
36—blower
37—indoor heat exchanger
38—second heat exchanger, e.g., plate type heat exchanger
40—fluid conductor
42—fluid conductor
44—fluid conductor
46—fluid conductor
48—controller
50—bypass fluid conductor
52—refrigerant flow
54—switch
56—port
58—port
60—port
62—port
64—valve body
66—spool
68—switch
70—port
72—port
74—port
76—port
78—port
80—port
82—valve body
84—spool
86—electric battery
88—space heating or cooling battery
90—indoor/outdoor heat exchanger
92—fluid conductor
94—demand forecast module
96—grid command module
98—electricity pricing module
100—battery controller
102—appliance

### Particular Advantages of the Invention

The present heating system or heating and cooling system does not include a tank for storing potable hot water in anticipation of a potable hot water demand. As such, no stratification of potable water held in a tank can occur. Although one or more temperature sensors may be used for providing feedback to heating of the contents of a tank water heater to achieve a setpoint temperature, the effect of stratification can cause layers of fluid having different temperatures in the tank water heater. Therefore, although portions of the contents of a water heater may be disposed at a setpoint temperature that is unfavorable for Legionella proliferation, there may be other portions that are disposed at temperatures suitable for Legionella proliferation, especially when the contents have been left unused for an extended period of time.

The present heating system or heating and cooling system is capable of storing heat energy harnessed from an outdoor ambient of a heat exchanger. In one mode, the heat exchanger disposed outdoor is useful for drawing heat subsequently transferred to be stored in a bath of a tank. In one embodiment, the present heating system or heating and cooling system is capable of storing heat energy harnessed from an indoor ambient of an indoor heat exchanger. In one mode, the air handler disposed outdoor is useful for drawing heat subsequently transferred to be stored in the bath of the tank. In one embodiment, the present heating system or heating and cooling system is capable of storing heat energy obtained from an indoor or outdoor environment. In one embodiment, supplemental or additional heat energy can be supplied by heating elements disposed within the bath of the present tank and powered by grid electricity, solar power means and wind power means. In one embodiment, hot water can be provided even in the event of an electric power failure as a demand of hot water can be met by heating the incoming cold water supply with the heat energy stored in a tank.

As the present heating system or heating and cooling system includes a domestic water supply that is not fluidly connected to a tank characterized by a low flowrate within the tank, the present system significantly reduces the opportunity for a water flow to deposit scale within the water conductor of the system as the water flow occurs through fluid conductors of a smaller inner diameter instead of the significantly larger volume of a tank.

As the present heating system or heating and cooling system includes an electric battery, the present system reduces the downtime if grid power is down as the system continues to be operational even if grid power is not available. Further, the electric battery serves as a sink for electric grid power when its pricing is favorable or low or when the demand for grid power is low.

Hard water causes unwanted mineral deposits (scaling) on the fluid contact surfaces of the water heater system. Severe scaling can cause severe drop in the water heater efficiency and life span. Scale deposits in the interior surfaces of heat exchanger tubes can reduce the heat exchanger efficiency as the scale deposits reduce heat transfer rate from the exterior to the interior surfaces of the heat exchanger tubes. Therefore, more heat would be required to raise each degree of water temperature. Excessive scale deposits, or any other like issues, that cause reduced heat exchanger efficiency, can lead to overheating of the exterior surfaces of a heat exchanger resulting in a shortened heat exchanger service life. In addition to resulting in damage to the heat exchanger, overheating of exterior surfaces of the heat exchanger, leads to undue energy loss. As the contents or bath of the present tank is isolated from the domestic water delivered to an end user, the speed of a flow through the domestic water conductor is significantly higher than a flow through a tank, thereby reducing the likelihood that scaling can occur.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

When used in conjunction with a heat pump herein, the term “turn on” or “drive” means to turn on the blower 16, compressor 10 and switches, e.g., hydraulic switches, associated with the heat pump. A turned-on heat pump produces an output in the form of heat transfer from a source side to a sink side. When used as a heater with a heat pump capable of providing heating or cooling, the switches are disposed in a setting useful for the heat pump to provide heating in which the heat pump draws heat to be used in heating air in a space, heating a flow of water or heating a medium stored in a thermal battery. When used as a space cooling device, the switches are disposed in a setting useful for the heat pump to provide cooling in which the same heat pump draws heat from air in a space or a medium and rejects it elsewhere. A heat pump as shown herein or a generic heat pump can be turned on by using or discharging an electric battery or using wall power or grid electricity. Several devices are said to be disposed in a synergistic relationship when the operations of one or more devices benefit other devices in the system. For instance, when thermal energy can be pre-stored in a thermal battery, the heating load required of a heat pump can be lessened or a heating demand can be met more quickly as the energy stored in the thermal battery can be readily dispensed for meeting the demand. Further, if the stored heat is not used in a timely fashion, this heat may be lost without its benefits being realized in supplementing heating. As another example, charging of a thermal battery allows excess heat of a space to be removed, in space cooling, and be stored in the thermal battery for later use in water and/or space heating. It shall be noted that the single act of charging the thermal battery, e.g., by turning on a heat pump, not only benefits space cooling by removing heat but also water and/or space heating at a later time.

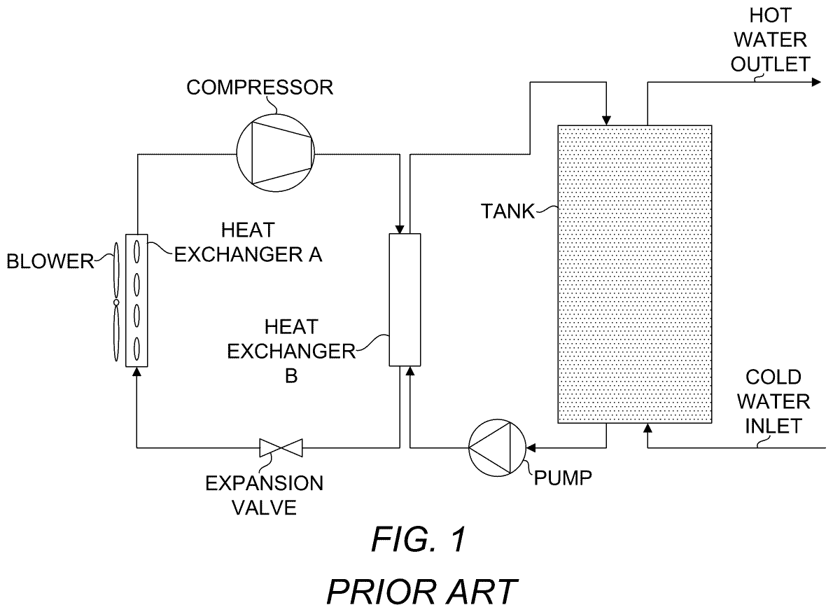

FIG. 1 is a diagram depicting a prior art electric domestic water heating system. The heating system includes a heat pump including a compressor operable to circulate a heat transfer fluid in a first fluid conductor, a heat exchanger, i.e. heat exchanger A, a blower operable to supply a stream of fluid over heat exchanger A. Heat exchanger A and the compressor are fluidly connected to the first fluid conductor and heat exchanger A being disposed to transfer heat between the heat transfer fluid and the heat exchanger A whereby heat is transferred between the heat transfer fluid and the stream of fluid over heat exchanger A. The heating system further includes a tank and a pump operable to circulate a domestic water flow in a second fluid conductor and through the tank. A second heat exchanger, i.e., heat exchanger B, thermally couples the first fluid conductor and the second fluid conductor and it is disposed to transfer heat between the heat transfer fluid and the domestic water flow. It shall be noted that, in one mode, the compressor circulates the heat transfer fluid in the first fluid conductor and the pump to circulate the domestic water flow in the second fluid conductor through the tank in response to a hot water demand. The compressor circulates the heat transfer fluid in the first fluid conductor while the pump circulates the domestic water flow in the second fluid conductor in response to a thermal charging demand of the domestic water in the tank. It shall be noted that the domestic water flow is fluidly connected to the contents of the tank. Therefore, a domestic water flow through the tank is subject to any temperature stratification effects that can occur in the tank. As the domestic water received at the tank flows through a large body of water in the tank, some portions of the contents of the tank can be said to stagnate, a condition suitable for Legionella proliferation. A flow through a tank or a large container is characterized by its low speed and there is no guaranty that a flow that enters first into the tank will exit the tank first, leaving behind portions of the contents of the tank having a dwell time suitable for Legionella proliferation. Further, it is possible that portions of the domestic water in the tank are disposed at a temperature that falls within a range of temperature suitable for Legionella proliferation.

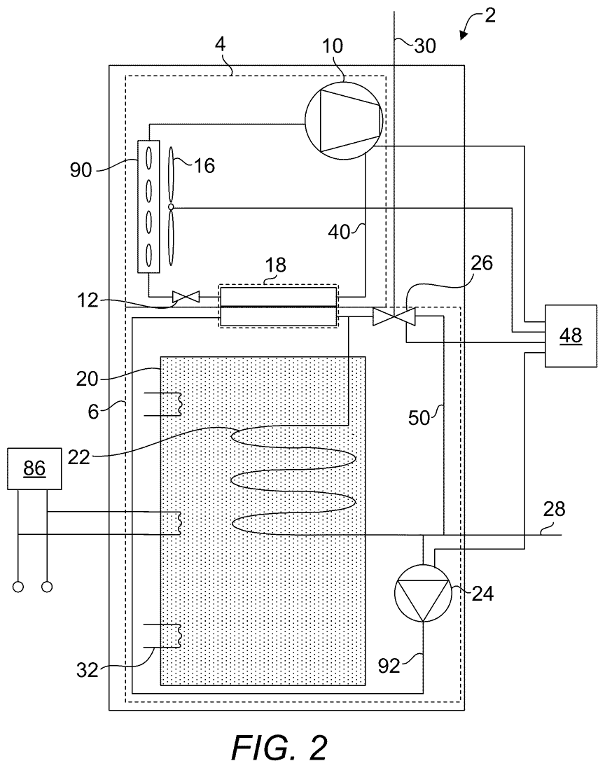

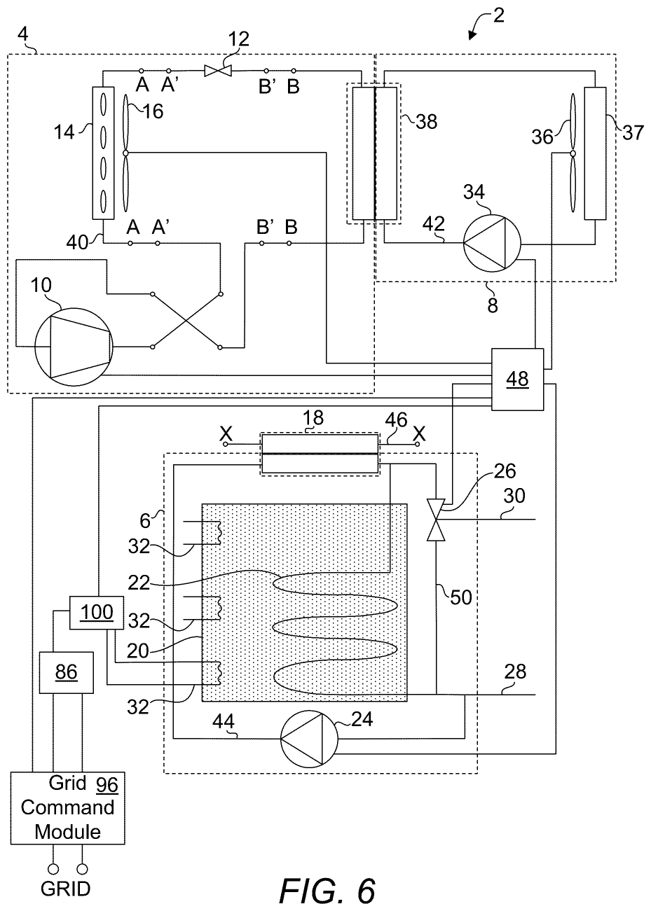

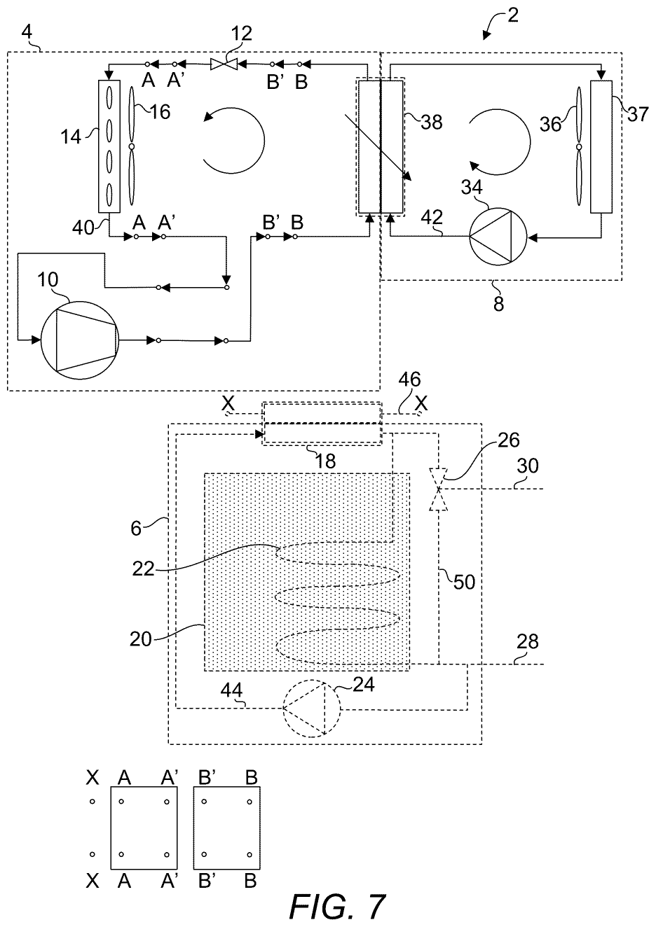

FIG. 2 is a diagram depicting a present electric domestic water heating system 2. The heating system 2 includes essentially two subsystems 4, 6. As used herein and throughout the specification and drawings, a subsystem is shown to include components disposed within a box with dashed lines. Subsystems, devices, components and fluid conductors that are inactive or otherwise not involved in the operation of a system are also shown in dashed lines to ease comprehension of the drawings. Subsystem 4 includes a heat pump including a first fluid moving device 10, e.g., compressor, operable to circulate a first heat transfer fluid in a first fluid conductor 40, an indoor/outdoor heat exchanger 90, e.g., evaporator, a first blower 16 operable to supply a stream of fluid over the indoor/outdoor heat exchanger 90, wherein the indoor/outdoor heat exchanger 90 and the first fluid moving device 10 are fluidly connected to the first fluid conductor 40 and the indoor/outdoor heat exchanger 90 being disposed to transfer heat between the first heat transfer fluid 40 and the indoor/outdoor heat exchanger 90 whereby heat is transferred between the first heat transfer fluid and the stream of fluid over the indoor/outdoor heat exchanger 90. In one embodiment, the first heat transfer fluid is a refrigerant, e.g., carbon dioxide. In the embodiment shown, wherein the heat pump further includes an expansion valve 12 fluidly connected to the first fluid conductor. Subsystem 6 includes a tank 20 including a bath, a second fluid moving device 24, e.g., pump, operable to circulate a second heat transfer fluid received through inlet 28 in a second fluid conductor 92. The second heat exchanger 18 and the second fluid moving device 24 are fluidly connected to the second fluid conductor 92 and a portion of the second fluid conductor is disposed through the bath of the tank 20. It shall be noted that the second fluid conductor is not fluidly connected to the tank 20 and therefore the contents or bath of the tank 20 is isolated from the domestic water delivered to an end user, eliminating any ill effects of potential Legionella proliferation due to the tank 20. There is further provided a first heat exchanger 18 disposed to transfer heat between the first heat transfer fluid and the second heat transfer fluid. Subsystem 6 further includes a mixing valve 26 including two input ports and a discharge port, one of the two input ports fluidly connected to a first end of the portion of the second fluid conductor via a bypass fluid conductor 50 and the other one of the two input ports fluidly connected to a second end of the portion of the second fluid conductor and the discharge port connected to an outlet of the second fluid conductor. A controller 48 is further provided and operably connected to the first fluid moving device 10, the mixing valve 26, the second fluid moving device 24 and the blower 16. In the embodiment shown, subsystem 6 further includes an electric battery 86 configured for storing electric power and powering at least one of the first fluid moving device 10, the blower 16, the second fluid moving device 24, the mixing valve 26 and the controller 48. In one embodiment, the operation of the blower 16 mirrors the operation of the first fluid moving device 10. In other words, when the first fluid moving device 10 is turned on, the blower 16 is turned on as well and when the first moving device 10 is turned off, the blower 16 is turned off as well. A grid command module 96 is provided to facilitate the backfeeding of electricity to the grid. For the sake of simplicity, the grid command module 96, battery 86 and a battery controller 100 which controls supplemental heating of the contents of the thermal storage device 20, are only shown in FIG. 6 although it is to be understood that these components can exist in at least the systems shown in FIGS. 7-13.

The price of electricity supply via an electricity grid can vary over the course of a day according to its demand. For instance, during periods of peak demand for electricity and when its supply is insufficient to cover the demand or when its supply barely meets the demand, electricity is priced at a higher level than when the supply well exceeds the demand. Therefore, it may be advantages to utilize electricity from the grid to charge the electric battery 86 in order to store electrical energy in the electric battery 86 in anticipation for later use when grid electricity is more costly. Alternatively and/or additionally, grid electricity can be used to generate heat energy stored in the tank 20 via one or more supplementary heating elements 32 or subsystem 4 even when there is not an immediate need for hot water when the cost of grid electricity is low but a need is anticipated to fall within a period in which additional heat energy can be stored in tank 20 without significant losses, e.g., at or over about 5% of the additional heat energy stored. The cost of grid electricity may be observed and analyzed using the controller 48 by receiving grid electricity pricing data, e.g., over the internet.

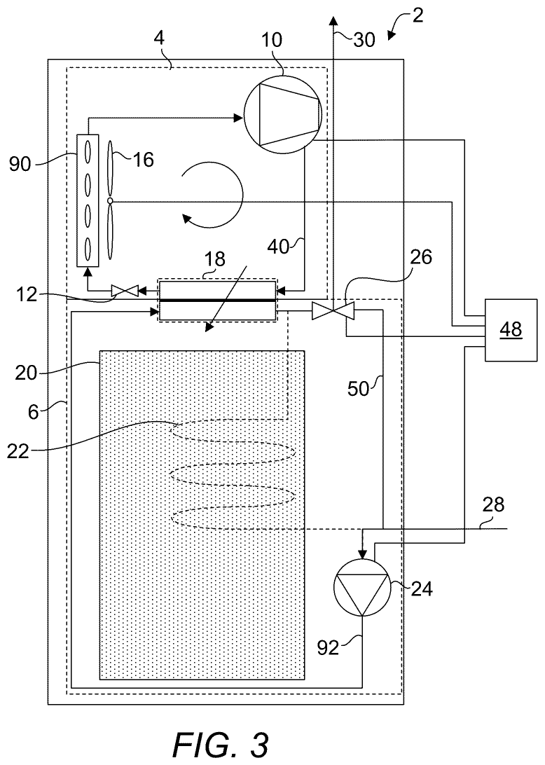

In the embodiment shown, the portion 22 of the second fluid conductor disposed through the bath or immersed in the bath of the tank 20 is a coiled tube heat exchanger being disposed to transfer heat between the bath and the second heat transfer fluid. Note that there is no fluid communication between the bath and the second heat transfer fluid. As such, the second heat transfer fluid is not exposed to any risks associated with Legionella due to potential stratification of the bath of the tank 20. The bath can be water or a phase change material (PCM), e.g., paraffins, etc. Water is used both as a second heat transfer fluid when it is used to receive heat from the bath of the tank 20 while being circulated through the bath of the tank 20 as disclosed elsewhere herein or as a resource that is consumed by a user when supplied through outlet 30 as shown in FIG. 3.

FIG. 3 is a diagram depicting the present electric domestic water heating system of FIG. 2 being used to provide a hot water supply. As used herein, arrows are used to show the direction of travel of the first or second heat transfer fluid. The controller 48 is operable to control the first fluid moving device 10 to circulate the first heat transfer fluid in the first fluid conductor 40 and the second fluid moving device 24 to circulate the second heat transfer fluid in the second fluid conductor in response to a first hot water demand. The fluid moving device 10, e.g., compressor, compresses the refrigerant, increasing its temperature. At heat exchanger 18, the first heat transfer fluid condenses, giving off heat that is subsequently transferred from the first heat transfer fluid to the second heat transfer fluid. The second heat transfer fluid is domestic water circulated by the second fluid moving device 24, before exiting the hot water outlet 30. Upon exiting heat exchanger 18, the first heat transfer fluid enters an expansion valve 12 which reduces its pressure. At significantly reduced pressure, the first heat transfer fluid enters heat exchanger 90, e.g., evaporator, where heat is transferred from the environment of heat exchanger 90 to the first heat transfer fluid. As the blower 16 blows across the heat exchanger 90, the first heat transfer fluid absorbs heat and evaporates. The first fluid moving device 10 continues to compress the refrigerant, increasing its temperature and this cycle continues. Note that the portion 22 of the second fluid conductor is not active in this mode as pump 24 draws the second heat transfer fluid through it, starving a flow through the tank 20 while the mixing valve 26 blocks a flow through bypass fluid conductor 50.

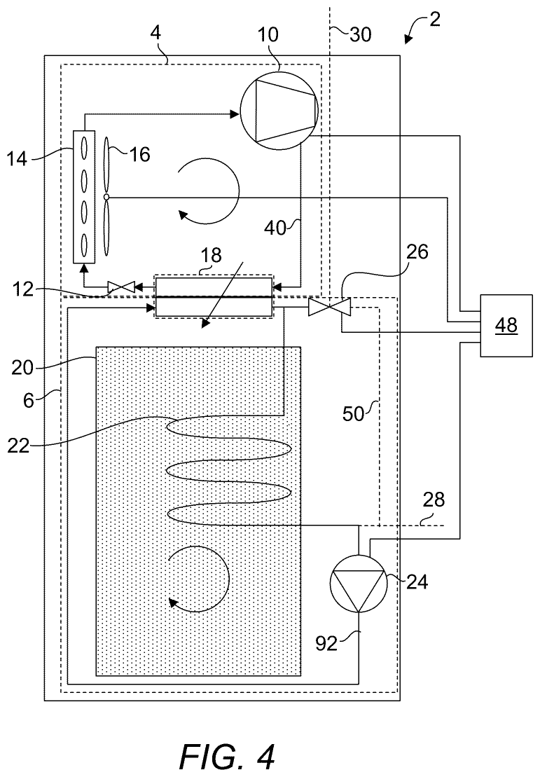

FIG. 4 is a diagram depicting the present electric domestic water heating system of FIG. 2 being used to charge a thermal battery, i.e., the tank 20. Here, the controller is further operable to control the first fluid moving device 10 to circulate the first heat transfer fluid in the first fluid conductor 40 and the second fluid moving device 24 to circulate the second heat transfer fluid in the second fluid conductor 40 in response to a thermal charging demand of the bath of the tank 20.

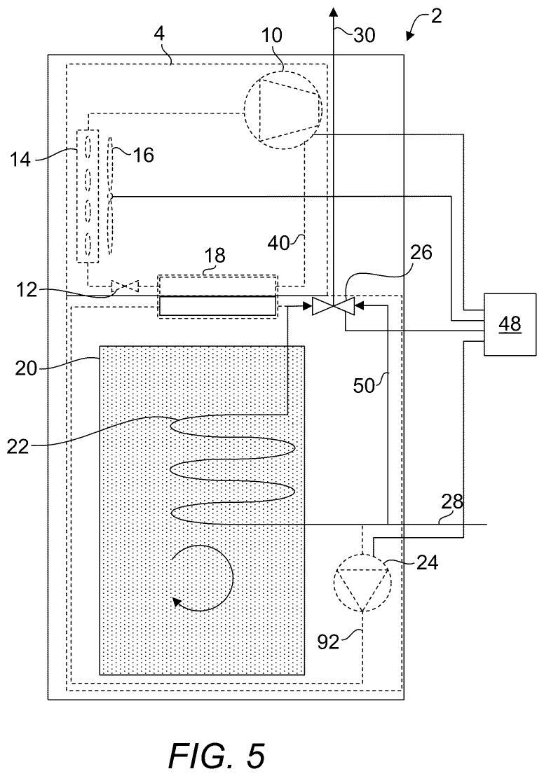

FIG. 5 is a diagram depicting the present electric domestic water heating system of FIG. 2 being used to provide a hot water supply. Here, the controller is further operable to control the mixing valve 26 to allow mixing of the second heat transfer fluid through the portion 22 of the second fluid conductor and the bypass conductor in response to a second hot water demand. Note that FIGS. 2-5 each depicts primarily a domestic water heating system. The indoor/outdoor heat exchanger and its blower may be disposed either in an indoor or outdoor environment. If disposed in an indoor environment, they can additionally act as a space cooling system as it removes heat energy from the space and transfers the same to the domestic water. If disposed in an outdoor environment, heat energy is drawn from the outdoor environment to the domestic water.

FIG. 6 is a diagram depicting an electric domestic water heating, space heating and cooling system 2. The heating and cooling system 2 includes a first subsystem 4, 8 and a second subsystem 6. The first subsystem 4, 8 is configured for temperature conditioning of an indoor space, the first subsystem including a first heat exchanger 38, a heat pump and a second fluid moving device 34. In one embodiment, the second fluid moving device 34 is a pump. The heat pump includes a first fluid moving device 10 operable to circulate a first heat transfer fluid in a first fluid conductor 40, an outdoor heat exchanger 14, a first blower 16 operable to supply a stream of fluid over the outdoor heat exchanger 14, a pair of first hydraulic switches A-A′ disposed about the outdoor heat exchanger 14. In one embodiment, the first heat transfer fluid is refrigerant, e.g., carbon dioxide.

The pair of first hydraulic switches are operable to disconnect the outdoor heat exchanger 14 from the first fluid conductor 40. A pair of second hydraulic switches B-B′ are disposed about the first heat exchanger 38 where the pair of second hydraulic switches are operable to disconnect the first heat exchanger 38 from the first fluid conductor 40 and to connect the fourth fluid conductor 46 to the pair of second hydraulic switches. An outdoor heat exchanger can be any device, e.g., coil tube, configured to encourage heat energy exchanges between a fluid contained within the device with a fluid surrounding the device and typically disposed in an outdoor environment. The outdoor heat exchanger 14 and the first fluid moving device 10 are fluidly connected to the first fluid conductor 40 and the outdoor heat exchanger 14 is disposed to transfer heat between the first heat transfer fluid and the outdoor heat exchanger 14, whereby heat is transferred between the first heat transfer fluid and the stream of fluid over the outdoor heat exchanger 14. In one embodiment, the operation of the first blower 16 mirrors the operation of the first fluid moving device 10. In other words, when the first fluid moving device 10 is turned on, the first blower 16 is turned on as well. In one embodiment, the operation of the second blower 36 mirrors the operation of the second fluid moving device 34. In other words, when the second fluid moving device 34 is turned on, the second blower 36 is turned on as well.

The second fluid moving device 34 is operable to circulate a second heat transfer fluid in a second fluid conductor 42, an indoor heat exchanger and a second blower 36 operable to supply a stream of fluid over the indoor heat exchanger 37. In one embodiment, the second heat transfer fluid is water. The indoor heat exchanger 37 and the second fluid moving device 34 are fluidly connected to the second fluid conductor 42 and the indoor heat exchanger 37 is disposed to transfer heat between the second heat transfer fluid and the indoor heat exchanger 37, whereby heat is transferred between the second heat transfer fluid and the stream of fluid over the indoor heat exchanger 37. An indoor heat exchanger can be any device, e.g., coil tube, configured to encourage heat energy exchanges between a fluid contained within the device a fluid surrounding the device and typically disposed in an indoor environment. The second subsystem 6 is configured for heating a liquid, the second subsystem including a second heat exchanger 18, a tank 20 including a bath, a third fluid moving device 24 operable to circulate a third heat transfer fluid in a third fluid conductor 44, a mixing valve 26 and a fourth fluid conductor 46. The portion 22 of the third fluid conductor 44 disposed through the bath or immersed in the bath of the tank 20 is a heat exchanger, e.g., coiled tube heat exchanger, being disposed to transfer heat between the bath and the third heat transfer fluid. In one embodiment, the third heat transfer fluid is water. The second heat exchanger 18 and the third fluid moving device 24 are fluidly connected to the third fluid conductor and a portion of the third fluid conductor is disposed through the bath of the tank 20 and the third fluid conductor is not fluidly connected to the tank 20. Again, it shall be noted that the third fluid conductor is not fluidly connected to the tank 20 and therefore the contents or bath of the tank 20 is isolated from the domestic water delivered to an end user via outlet 30, eliminating any ill effects of potential Legionella proliferation due to the tank 20. In one embodiment, the third fluid moving device 24 is a pump. In one embodiment, the bath includes water. In another embodiment, the bath includes a phase change material (PCM).

The mixing valve 26 includes two input ports and a discharge port, one of the two input ports, i.e., the first port, fluidly connected to a first end of the portion of the third fluid conductor via a bypass fluid conductor 50 and the other one of the two input ports, i.e., the second port, fluidly connected to a second end of the portion of the third fluid conductor and the discharge port connected to an outlet of the third fluid conductor. The fourth fluid conductor 46 includes two ends, i.e., the two ends terminated at X-X, wherein the second heat exchanger 18 being disposed to transfer heat between the third heat transfer fluid and a fluid within the fourth fluid conductor 46, i.e., the heat transfer fluid of the first fluid conductor once the fourth fluid conductor 46 has become active as X-X has been connected to the first fluid conductor 40. In the embodiment shown in FIG. 6, the heating and cooling system 2 further includes an electric battery 86 configured for storing electric power and powering the first fluid moving device 10, the first blower 16, the pair of first hydraulic switches, the pair of second hydraulic switches, the second fluid moving device 34, the second blower 36, the second fluid moving device 34, the third fluid moving device 24, the mixing valve 26 and the controller 48. Here, the electric battery 86 is shown to power at least one supplementary heating element 32 disposed within the bath of the tank 20 and operably connected to the electric battery 86. A supplementary heating element 32 can be powered by grid electricity or alternatively or additionally be connected to another heating source, e.g., a solar electric or hydronic system, etc. A controller 48 is further provided and operably connected to the first fluid moving device 10, first blower 16, mixing valve 26, second fluid moving device 34, second blower 36 and third fluid moving device 24.

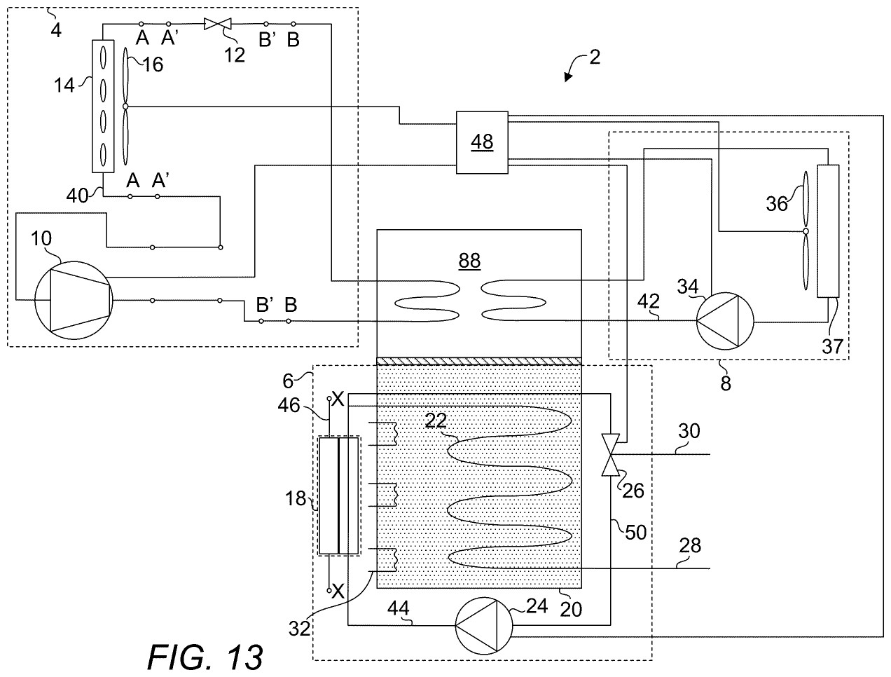

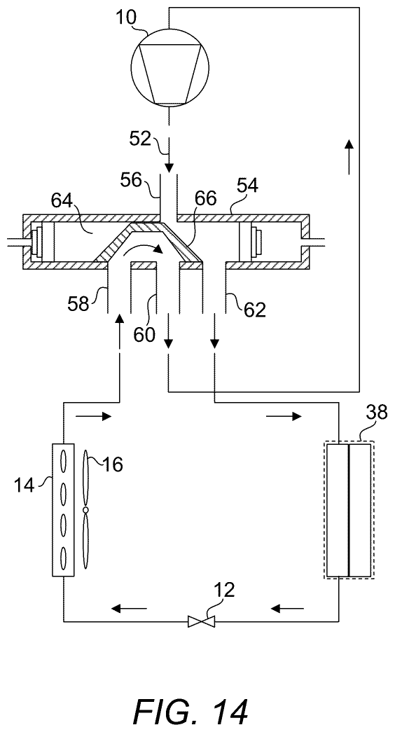

FIG. 7 is a diagram depicting an electric domestic water heating, space heating and cooling system of FIG. 6 being used to provide space heating. It shall be noted that the flow direction of the first heat transfer fluid is now reversed as compared to the configuration shown in FIG. 6. In achieving this flow direction reversal, the heating and cooling system 2 further includes a hydraulic switch configured for reversing a direction of operation of the first fluid moving device 10. One example of the hydraulic switch is disposed in FIGS. 14 and 15. The controller is further operable to control the first fluid moving device to circulate the first heat transfer fluid in a second direction in the first fluid conductor 40, the second fluid moving device 34, the first blower 16 and the second blower 36 in response to a space heating demand. In each of FIGS. 7-11, the status of switches A-A′ and B-B′ are further indicated to facilitate the understanding of the different operating modes disclosed therein. Closed switches where contacts or fluid connections are made are shown in a common block. For instance, in FIG. 7, switch A-A is connected to switch A′-A′ where fluid connection is possible between the segments of fluid conductors terminated with these switches and switch B′-B′ is connected to switch B-B where fluid connection is possible between the segments of fluid conductors terminated with these switches. Switch X-X is not connected to another fluid circuit and therefore shown as an unconnected switch. Note that heat energy is received from the ambient environment of heat exchanger 14 and transferred to the ambient environment of heat exchanger 37.

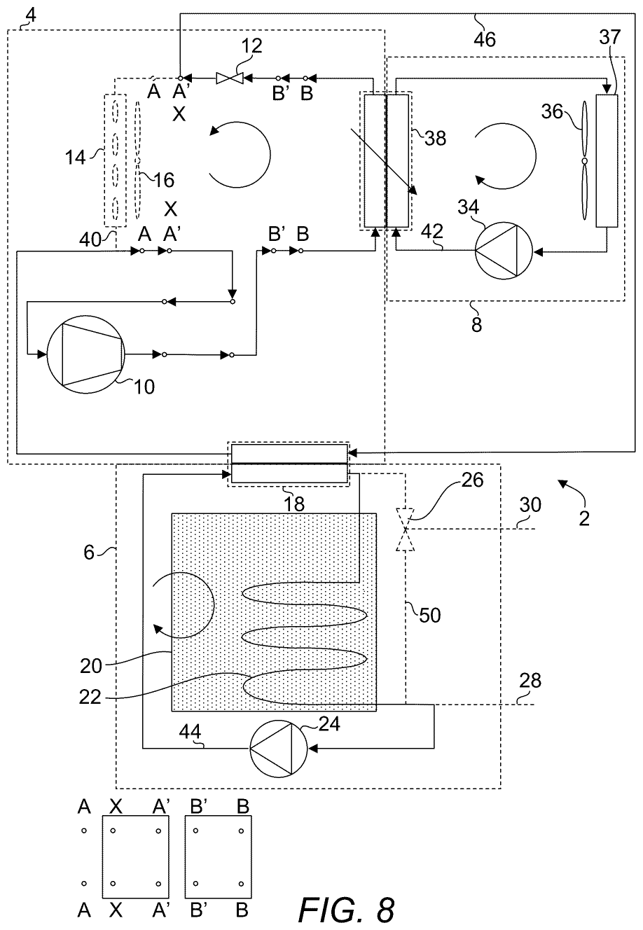

FIG. 8 is a diagram depicting an electric domestic water heating, space heating and cooling system of FIG. 6 being used to provide space heating. The controller is further operable to cause the two ends X-X to be fluidly connected to the pair of first hydraulic switches, the pair of first hydraulic switches disposed in a position to disconnect the outdoor heat exchanger 14 from the first fluid conductor, the third fluid moving device to circulate the third heat transfer fluid and the first fluid moving device to circulate the first heat transfer fluid in the second direction, the first blower to turn on, the second fluid moving device to circulate the second heat transfer fluid and the second blower to turn on in response to a space heating demand. Note that heat energy is transferred from the tank 20 to the ambient environment of heat exchanger 37.

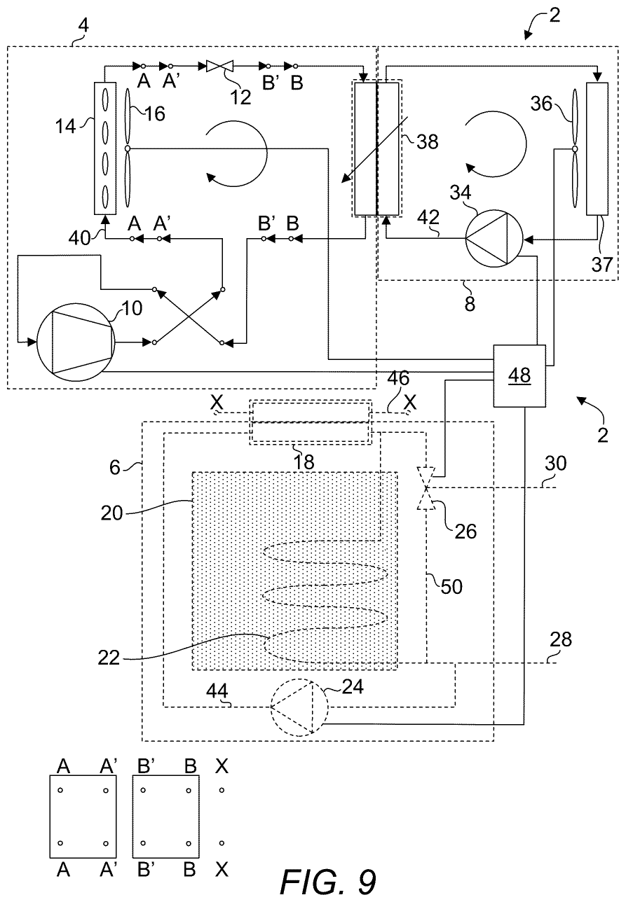

FIG. 9 is a diagram depicting an electric domestic water heating, space heating and cooling system of FIG. 6 being used to provide space cooling. The controller 48 is further operable to control the first fluid moving device to circulate the first heat transfer fluid in a first direction in the first fluid conductor 40, the first blower 16, the second blower 36 and the second fluid moving device 34 in response to a space cooling demand. Note that heat energy is removed from the ambient environment of heat exchanger 37 and transferred to the ambient environment of heat exchanger 14.

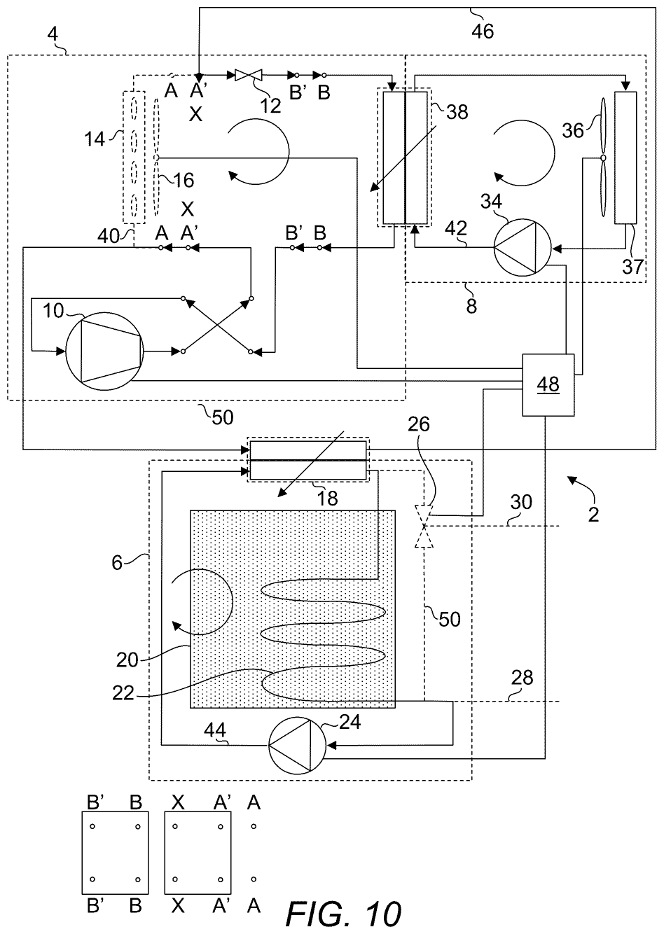

FIG. 10 is a diagram depicting an electric domestic water heating, space heating and cooling system of FIG. 6 being used to provide space cooling. The controller is further operable to cause the two ends to be fluidly connected to the pair of first hydraulic switches, the pair of first hydraulic switches disposed in a position to disconnect the outdoor heat exchanger 14 from the first fluid conductor, the third fluid moving device to circulate the third heat transfer fluid, the first fluid moving device to circulate the first heat transfer fluid in the first direction, the first blower 16 to turn on, the second fluid moving device to circulate the second heat transfer fluid and the second blower 36 to turn on in response to a space cooling demand. Note that heat energy is removed from the ambient environment of heat exchanger 37 and transferred to be stored in tank 20.

FIG. 10A is a diagram depicting an electric domestic water heating, space heating and cooling system of FIG. 6 being used to store heat energy. In this mode, the first fluid moving device 10 is a compressor and the outdoor heat exchanger 14 serves an evaporator. The heat pump further includes an expansion valve 12 fluidly connected to the first fluid conductor. The controller is further operable to cause the two ends to be fluidly connected to the pair of second hydraulic switches, the pair of second hydraulic switches disposed in a position to disconnect the first heat exchanger 38 from the first fluid conductor, the third fluid moving device to circulate the third heat transfer fluid, the first fluid moving device to circulate the first heat transfer fluid in the second direction, the first blower 16 to turn on, the mixing valve to close the first port and the second port in response to a thermal charging demand of the bath of the tank 20. Note that heat energy is removed from the ambient environment of heat exchanger 14 and transferred to heat the bath of the tank 20.

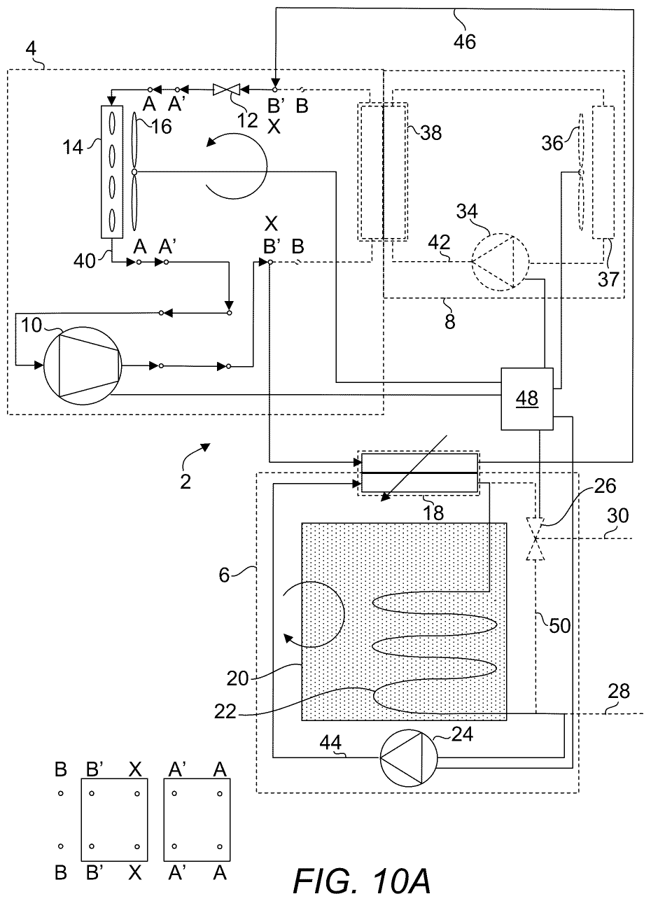

FIG. 11 is a diagram depicting an electric domestic water heating, space heating and cooling system of FIG. 6 being used to provide a hot water supply. In this mode, the first fluid moving device 10 is a compressor and the outdoor heat exchanger 14 serves an evaporator. The heat pump further includes an expansion valve 12 fluidly connected to the first fluid conductor. The controller is further operable to cause the two ends to be fluidly connected to the pair of second hydraulic switches, the pair of second hydraulic switches disposed in a position to disconnect the first heat exchanger 38 from the first fluid conductor, the third fluid moving device to circulate the third heat transfer fluid, the first fluid moving device to circulate the first heat transfer fluid in the second direction and the first blower 16 to turn on in response to a first hot water demand. Note that heat energy is removed from the ambient environment of heat exchanger 14 and transferred to heat a supply of domestic water.

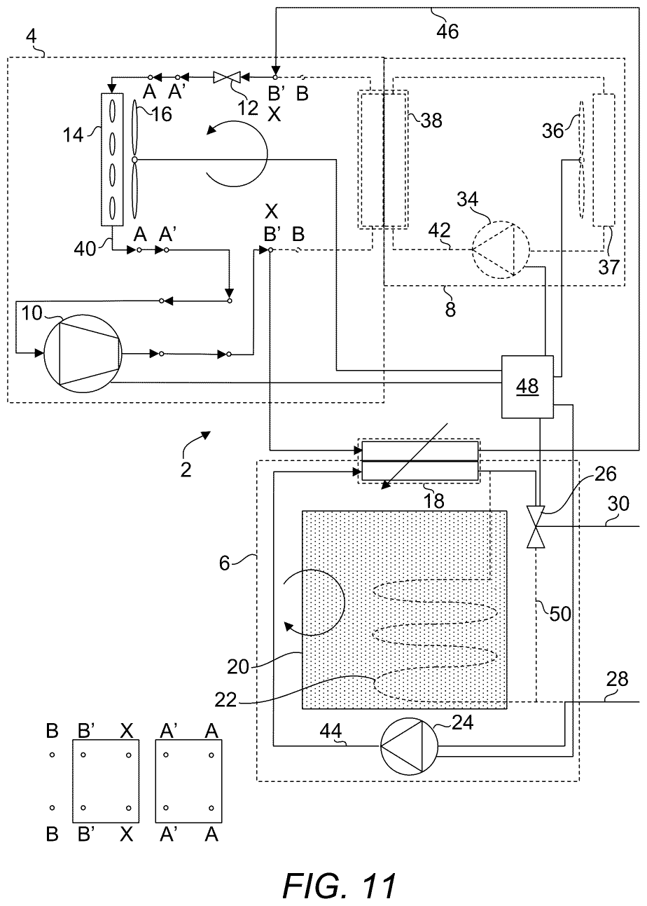

FIG. 12 is a diagram depicting an electric domestic water heating, space heating and cooling system 2 of FIG. 6 being used to provide a hot water supply. The controller is further operable to control the mixing valve 26 to allow mixing of the third heat transfer fluid through the portion 22 of the third fluid conductor and the bypass conductor 50 in response to a second hot water demand. Note that heat energy is drawn from the bath of the tank 20 and transferred to heat the third heat transfer fluid.

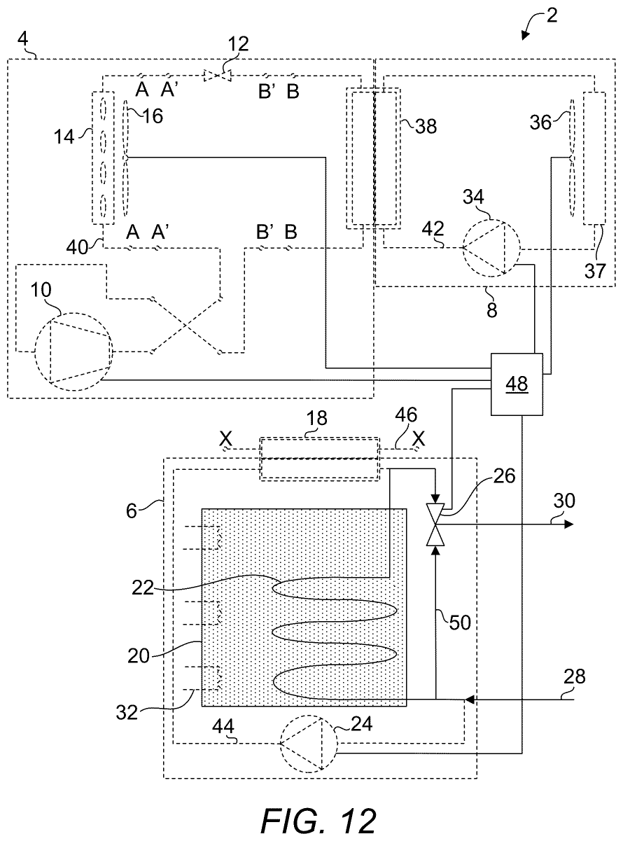

FIG. 13 is a diagram depicting an electric domestic water heating, space heating and cooling system 2 being used to provide a cold reservoir. In this embodiment, the first heat exchanger 38 includes a tank 88 including a bath, wherein the controller being further operable to control the first fluid moving device 10 to circulate the first heat transfer fluid in a first direction in the first fluid conductor 40 and the first blower 16 in response to a thermal discharging demand of the bath of the tank 88. The bath, e.g., water, of the tank 88 can therefore be disposed at a temperature lower than the ambient temperature of the outdoor heat exchanger 14. The controller being further operable to cause the two ends to be fluidly connected to the pair of first hydraulic switches, the pair of first hydraulic switches disposed in a position to disconnect the outdoor heat exchanger 14 from the first fluid conductor, the third fluid moving device to circulate the third heat transfer fluid and the first fluid moving device to circulate the first heat transfer fluid in the first direction in response to a thermal charging demand of the bath of the tank 20. Note that heat energy may be drawn from the bath of the tank 20 and transferred to the ambient environment of at least one of heat exchanger 14 and heat exchanger 37 by turning on the appropriate fluid moving device/s and blower/s.

FIG. 14 is a diagram depicting one embodiment of a switch 54 useful for reversing the flow of a flow loop where a valve spool of the switch 54 is disposed in a first position. Switch 54 is applicable to any one of the fluid moving devices disclosed elsewhere herein. Here, the switch 54 is a four-way two-position valve having a valve body 64 on which ports 56, 58, 60, 62 are disposed. Port 56 is connected to the effluent of compressor 10 while port 58 is connected to one end of heat exchanger 14 and port 60 feeds into compressor 10. Spool 66 is configured to slide along valve body 64 and spool 66 is disposed in a position to fluidly connect port 58 to port 60 and port 56 to port 62. Port 62 is connected to one end of heat exchanger 38. While disposed in this valve position, compressor 10 feeds into heat exchanger 38, making heat exchanger 38 a condenser. After passing expansion valve 12, the refrigerant flow through it expands. When the refrigerant flow passes through heat exchanger 18, the refrigerant evaporates, making heat exchanger 18 an evaporator.

FIG. 15 is a diagram depicting one embodiment of a switch 54 useful for reversing the flow of a flow loop where a valve spool is disposed in a second position. Switch 54 is applicable to any one of the fluid moving devices disclosed elsewhere herein. Here, the refrigerant flow 52 through each of heat exchanger 18, heat exchanger 38 and expansion valve 12 has been reversed as contrasted to the condition shown in FIG. 14. Here, spool 66 is disposed in a position to fluidly connect port 58 to port 60 and port 56 to port 58. Port 62 is connected to port 60. While disposed in this valve position, compressor 10 feeds into heat exchanger 14, making heat exchanger 18 a condenser. After passing expansion valve 12, the refrigerant flow through it expands. When the refrigerant flow passes through heat exchanger 38, the refrigerant evaporates, making heat exchanger 38 an evaporator.

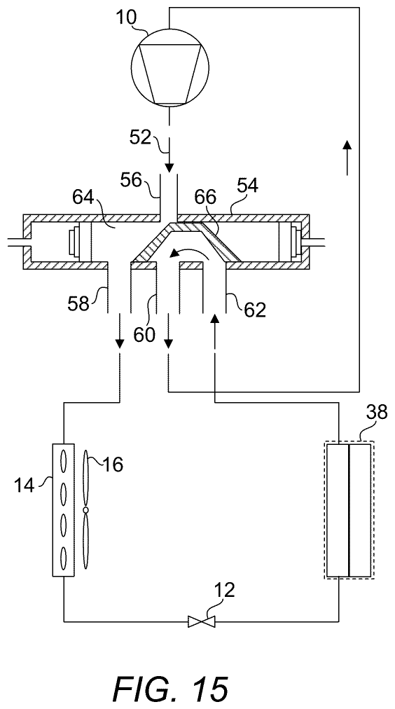

FIG. 16 is a diagram depicting one embodiment of a switch 68 useful for switching a first flow loop for a second flow loop where a valve spool is disposed in a first position. Switch 68 is applicable to any one of the flow circuits disclosed elsewhere herein. Here, switch 68 is a 6-way two-position valve having a valve body 82 on which ports 70, 72, 74, 76, 78, 80 are disposed. Port 70 is connected to a first end of heat exchanger 14 while port 76 is connected to a second end of heat exchanger 14. The position of the spool 84 allows fluid communication between port 70 or A and port 72 or A′ through a flow path disposed in the spool 84 and between port 76 or A and port 78 or A′ through another flow path disposed in the spool 84, making the circuit connected to A-A active. Port 74 or X and port 80 or X are blocked and therefore the circuit connected to X-X is rendered inactive.

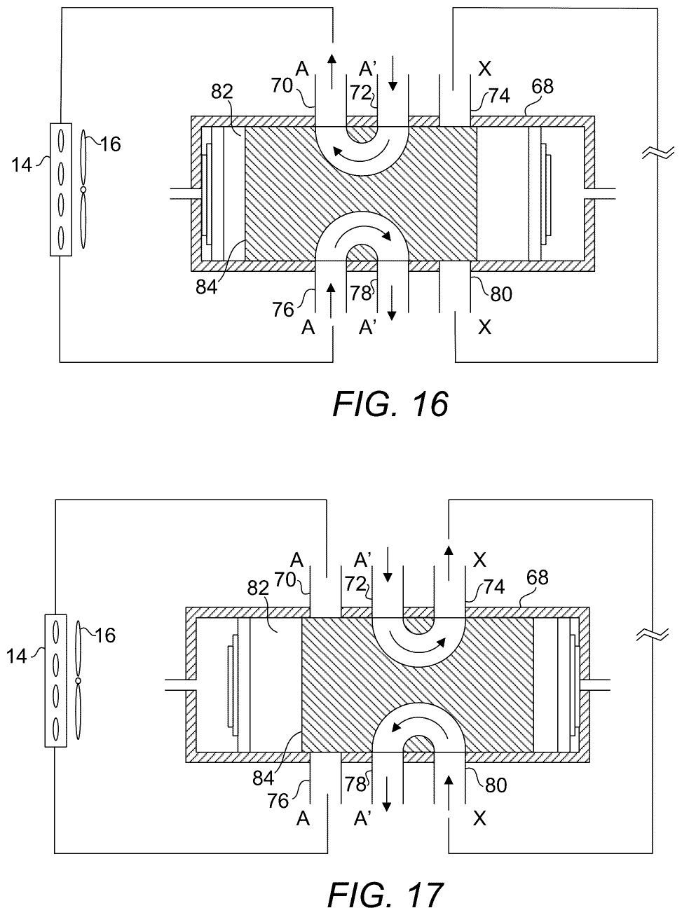

FIG. 17 is a diagram depicting one embodiment of 6-way two-position valve useful for switching a first flow loop for a second flow loop where a valve spool is disposed in a first position. Switch 68 is applicable to any one of the flow circuits disclosed elsewhere herein. Here, spool 84 is disposed in a position such that ports 70 or A and port 76 or A are now blocked and therefore the circuit connected to A-A is rendered inactive. Port 72 or A′ and 74 or X are now fluidly connected through a flow path disposed in the spool 84 and port 78 or A′ and 80 or X are now fluidly connected through a flow path disposed in the spool 84.

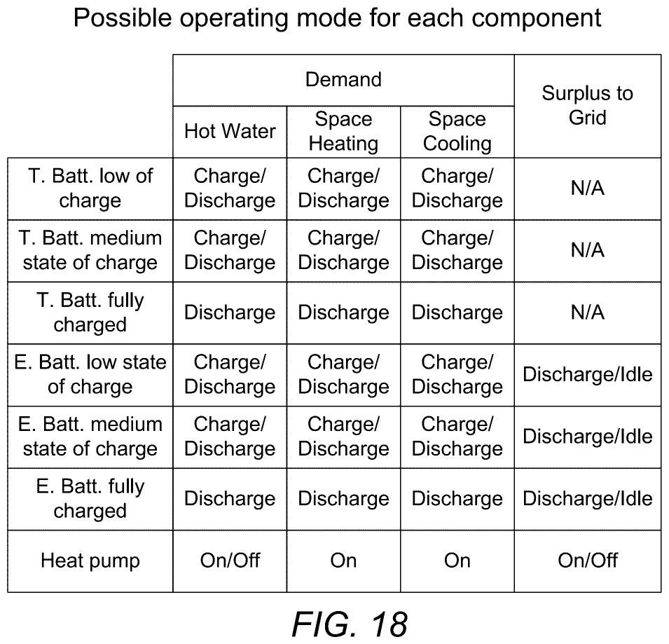

FIG. 18 is a diagram depicting possible operating modes of the devices shown in FIGS. 6-13. As various functions, e.g., hot water supply, space heating, space cooling, hot reservoir provision and backfeeding of electricity to grid can be supplied by synergistic components, the components referenced in the ensuing figures represent basic components which may be used to perform one or more functions. The components include a heat pump 2, e.g., of FIGS. 6-13, a thermal battery 20, e.g., of FIGS. 6-13 and an electric battery 86, e.g., of FIGS. 6-13 which can be used to perform functions disclosed elsewhere herein. In other words, each component is responsible for providing one or more functions by itself and/or by cooperating with one or more components in the system. Although FIGS. 18-22 are useful for summarizing a synergistic system including a heat pump, a thermal battery, an electric battery and a grid access system, this summary is applicable to systems that deviate from the system shown in FIGS. 6-13 without departing from the spirit of the invention.

In order to meet a hot water demand, the thermal battery can be configured to either be charged or to discharge depending on the charge level of the thermal battery. If the charge level is full, the thermal battery is configured to discharge only, e.g., in driving the equipment required for heating water, e.g., the equipment required to operate as shown in FIGS. 11 and 12, e.g., fluid moving device 24, compressor 10 and mixing valve 26. At medium and low charge levels, the thermal battery is configured to charge or discharge. The thermal battery is charged when additional thermal energy is being added to the thermal battery. A thermal battery full condition is defined as a condition where an attempt to further charge the thermal battery can no longer increase thermal storage of the thermal battery. In one embodiment, this condition can be indicated by an average temperature of the contents of the thermal battery, e.g., 20. When the thermal battery is not full, e.g., when the average temperature of the contents of the thermal battery is lower than a temperature indicating that the thermal battery is full, the thermal battery can be charged or discharged depending on the operational requirements of the system the thermal battery is a part of. For instance, if it is determined to be more favorable to charge the thermal battery to anticipate a discharge that will occur at a later time, the thermal battery can be charged for later use. In one example, the standard for being “favorable” is a scenario where the overall consumption of electricity of the synergistic system is minimized. In another example, the standard for being “favorable” is a scenario where the financial cost of consumption of the synergistic system is minimized.

The electric battery can be configured to either be charged or to discharge depending on the charge level of the electric battery. Again, if the charge level is full, the electric battery is configured to discharge only, e.g., in driving the equipment required for heating water, e.g., the equipment required to operate as shown in FIGS. 11 and 12, e.g., fluid moving device 24, compressor 10 and mixing valve 26. At medium and low charge levels, the electric battery is configured to charge or discharge. An electric battery full condition is defined as a condition where an attempt to further charge the electric battery can no longer significantly increase the electric storage of the electric battery. In one embodiment, this condition can be indicated by an output voltage of the electric battery which indicates that electric battery is fully charged. When the electric battery is not full, e.g., when an output voltage is lower than a voltage indicating that the electric battery is full, the electric battery can be charged or discharged depending on the operational requirements of the system the electric battery is a part of. For instance, if it is determined to be more “favorable” to charge the electric battery to anticipate a discharge that will occur at a later time, the electric battery can be charged for later use. In one example, again, the standard for being favorable is a scenario where the overall consumption of electricity of the synergistic system is minimized. In another example, the standard for being “favorable” is a scenario where the financial cost of consumption of the synergistic system is minimized. Note that in a conventional heat pump-based water heating, heat energy required for heating water or a space is acquired as a need for hot water or space heating arises. No provisions are made to store thermal energy for later use in water heating or space heating.

Regarding space heating, it shall be noted that the thermal battery and the electric battery are configured to follow the behaviors disclosed elsewhere herein for hot water heating. Referring to FIG. 18 and FIGS. 7 and 8, it shall be noted that if the thermal battery charge level is full, the thermal battery is configured to discharge only, e.g., in driving the equipment required for heating a space, e.g., the equipment required to operate as shown in FIGS. 7 and 8, e.g., pump 34, compressor 10, blower 16 and blower 36. At medium and low charge levels, the thermal battery is configured to charge or discharge. Note that in a conventional heat-pump based space heating system, heat energy required for heating a space is acquired as a need for space heating arises. No provisions are made to store thermal energy for later use in space heating.

Regarding space cooling, it shall be noted that the thermal battery and the electric battery are configured to again follow the behaviors disclosed elsewhere herein for hot water heating. Referring to FIG. 18 and FIGS. 9 and 10, it shall be noted that if the thermal battery charge level is full, the thermal battery is configured to discharge only, e.g., in driving the equipment required for heating a space, e.g., the equipment required to operate as shown in FIGS. 9 and 10, e.g., pump 34, compressor 10, fluid moving device 24 and blower 36. At medium and low charge levels, the thermal battery is configured to charge or discharge. Note that in a conventional space cooling system, heat extracted from a space is simply rejected to an outdoor environment. Instead, in the present synergistic system, instead of removing heat from a space to an outdoor environment, it is being stored in a thermal storage device 20 for later use.

Regarding the heat pump, the heat pump may or may not need to be turned on depending on the required function. FIG. 11 depicts a scenario where the heat pump 2 is turned on while FIG. 12 depicts a scenario where the heat pump 2 is not required to be turned on as the thermal battery 20 alone is sufficient in generating hot water to meet a hot water demand. FIGS. 7 and 8 depict scenarios where the heat pump 2 is turned on to meet a space heating demand although FIG. 8 shows that space heating can be supplemented with heat energy from the thermal battery. Although not shown, it is also conceivable to supplement space heating with electrical energy stored in the electric battery 86 via, e.g., resistive heating elements. FIGS. 9 and 10 both depict a scenario where the heat pump 2 is turned on to meet a space heating demand although FIG. 10 shows the thermal battery 20 is turned on to store heat rejected from space cooling.

Regarding surplus electricity, it can be seen that it is not directly applicable to the thermal battery. The surplus may be fed back to or supplied back to the grid, e.g., via the grid command module 96 shown in FIG. 6, which controls grid access of the present synergistic system to the grid, if desired. However, the surplus may continue to be kept in the electric battery 86, in which case, the mechanism allowing a backfeed to the grid remains idle. In addition to be an electricity storage device which enables synergies between components, the electric battery can also serve as an electric backup device for when a power outage occurs.

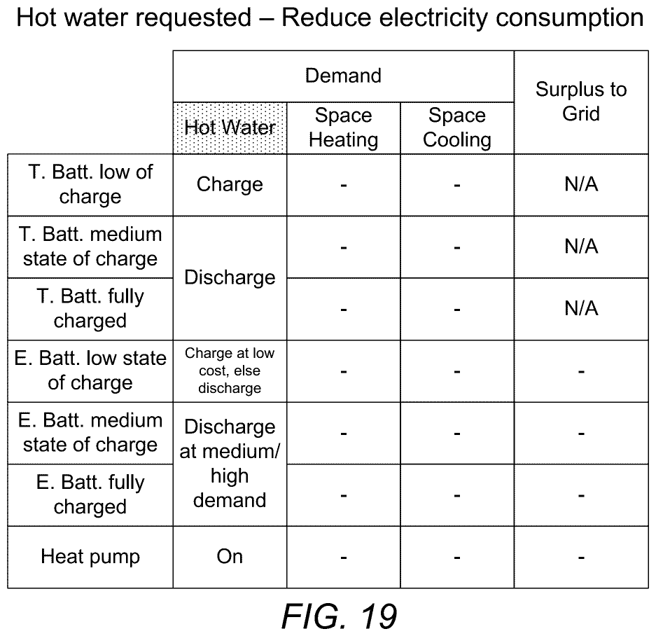

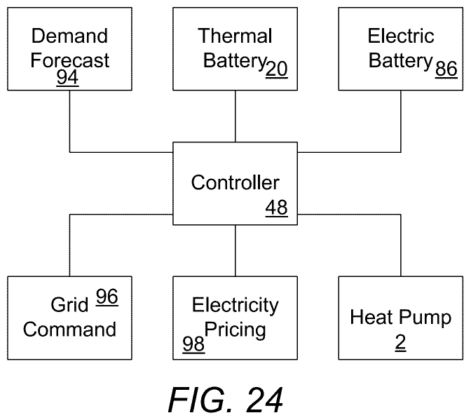

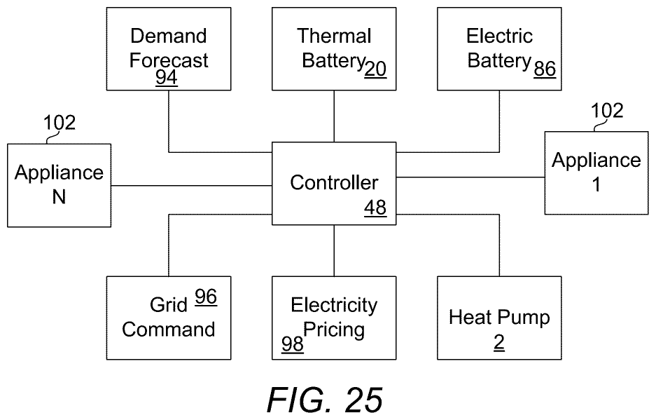

FIG. 19 is a diagram depicting possible operating modes of the devices shown in FIGS. 6-13 when hot water is requested. In one embodiment, when a hot water demand exists, the thermal battery is charged when the battery level is low. When the thermal battery is disposed at a medium level, e.g., 50% charge or more or when the thermal battery has already been fully charged, the thermal battery is configured to discharge. When the electric battery is disposed at a low level, e.g., between 0% to 49% charge, the electric battery will be charged, e.g., via the grid command module 96 if the electricity price is determined to be low by an electricity pricing module 98 shown in FIGS. 24 and 25. In one embodiment, the electricity pricing module 98 is a controller or an algorithm running on the controller configured to retrieve real time electricity pricing data remotely. This module can be made available locally or remotely to the synergistic system. For instance, if the electricity price is determined to be low during low electric customer usage periods, electricity may be stored in an electric battery for future use, especially during a period when electric pricing is significantly higher than the price at which the battery is charged. In some instances, the electricity pricing module 98 is a controller or an algorithm capable of retrieving future or anticipated electricity pricing data, e.g., for the next day or 24 hours. The time periods at which the electric battery is to be charged can be determined based on the anticipated electricity pricing data. However, if future or anticipated electricity pricing data is unavailable, historical electrical pricing data may be used to predict electricity pricing for time periods of a day, days of a week and weeks of a year, etc. When the battery is fully charged or disposed at a medium level, the battery is configured to supply or supplement electricity to drive the necessary equipment for water heating. The heat pump is turned on to cause heat transfer to the air surrounding a heat exchanger, e.g., heat exchanger 37 as shown in FIG. 7 and/or a water flow that exits, e.g., at outlet 30 as shown in either FIG. 11 or FIG. 12.

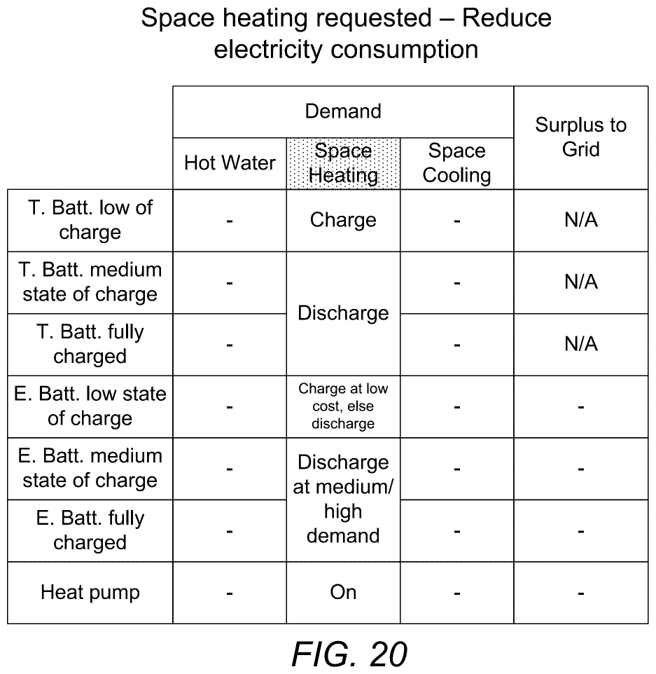

FIG. 20 is a diagram depicting possible operating modes of the devices shown in FIGS. 6-13 when space heating is requested. In one embodiment, when a space heating demand exists, the thermal battery is charged when the battery level is low. When the thermal battery is disposed at a medium level, e.g., 50% charge or more or when the thermal battery has already been fully charged, the thermal battery is configured to discharge. When the electric battery is disposed at a low level, e.g., between 0% to 49% charge, the electric will be charged, e.g., via the grid command module 96 if the electricity price is determined to be low by an electricity pricing module 98 shown in FIGS. 24 and 25. When the battery is fully charged or disposed at a medium level, the battery is configured to supply or supplement electricity to drive the necessary equipment for space heating. The heat pump is turned on to cause air heating that occurs via heat exchanger 37, e.g., as shown in either FIG. 7 or FIG. 8.

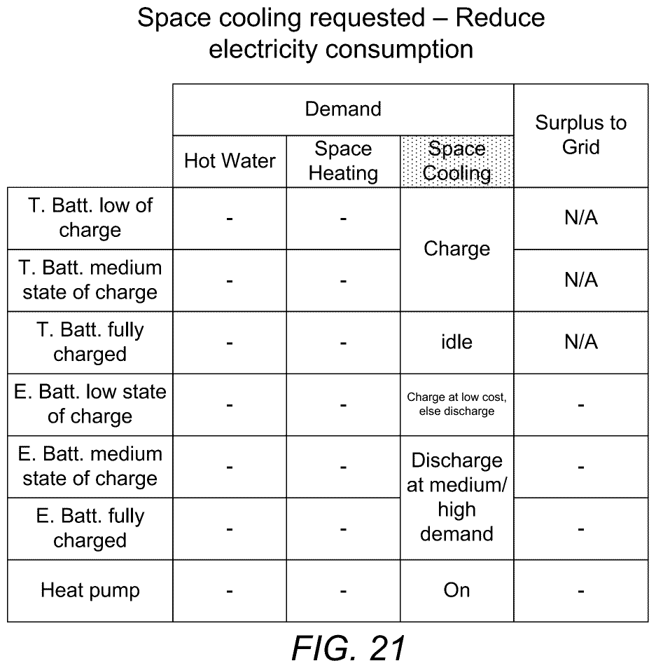

FIG. 21 is a diagram depicting possible operating modes of the devices shown in FIGS. 6-13 when space cooling is requested. In one embodiment, when a space cooling demand exists, the thermal battery is charged when the battery level is low or medium. When the thermal battery level is full, the thermal battery is configured to be idle as no additional heat can be transferred to the thermal battery. When the electric battery is disposed at a low level, e.g., between 0% to 49% charge, the electric will be charged, e.g., via the grid command module 96 if the electricity price is determined to be low by an electricity pricing module 98 shown in FIGS. 24 and 25. When the electric battery is fully charged or disposed at a medium level, the electric battery is configured to supply or supplement electricity to drive the necessary equipment for space cooling. The heat pump is turned on to cause air cooling that occurs via heat exchanger 37, e.g., as shown in either FIG. 9 or FIG. 10.

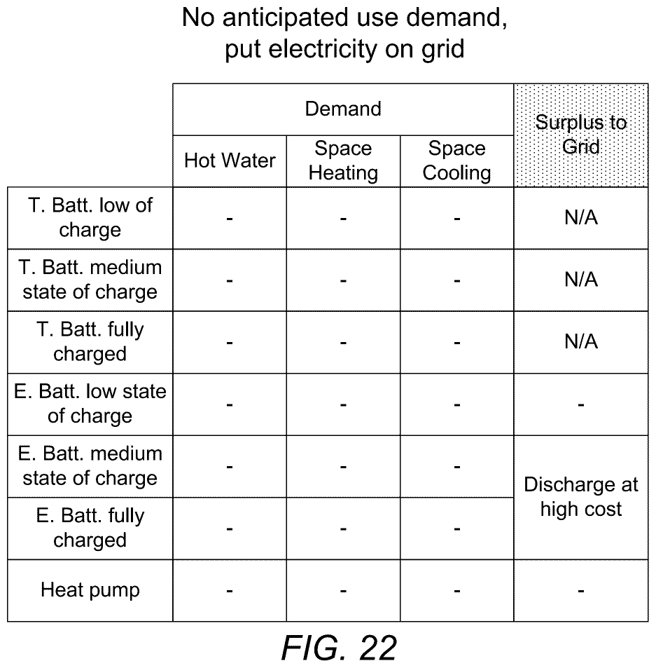

FIG. 22 is a diagram depicting possible operating modes of the devices shown in FIGS. 6-13 when no hot water, space heating and space cooling are requested. If sufficient electricity is stored in the battery at medium to full levels, electricity can be backfed to the grid if desired. This backfeed can be especially valuable when the electricity price is high considering the lower-cost electricity was used to store electricity in the electric battery. Again, the decision to activate this backfeed is based on whether the electricity pricing is favorable.

Therefore, it can be summarized that a method for controlling a system including a heat pump, a space heater, space cooler, a thermal battery, an electric battery and a grid access system has been provided. The method includes:
(a) turning on at least one of the heat pump, charging of the thermal battery, discharging of the thermal battery, charging of the electric battery and discharging of the electric battery if a hot water demand exists;
(b) turning on at least one of the heat pump, charging of the thermal battery, discharging of the thermal battery, charging of the electric battery and discharging of the electric battery if a space heating demand exists;
(c) turning on at least one of the heat pump, charging of the thermal battery, charging of the electric battery and discharging of the electric battery if a space cooling demand exists; and
(d) backfeeding electricity from the electric battery to a grid through the grid access system if electricity sale is desired.

In one embodiment, step (a) includes charging of the thermal battery by turning on the heat pump, e.g., as shown and described in the operating modes of FIGS. 11 and 12. In one embodiment, step (a) includes discharging the electric battery to turn on the heat pump as disclosed elsewhere herein or a generic heat pump configured to provide heating. In one embodiment, step (a) includes discharging the thermal battery to meet the entire hot water demand or to supplement water heating or to provide a portion of the total heat required to meet the hot water demand. If the thermal battery is discharged to supplement heating, the heating load demanded of the heat pump can be lessened. Further, with the use of both the heat pump and the thermal battery that has been sufficiently or fully charged, a larger hot water demand can be met. In one embodiment, step (a) includes charging the electric battery if electricity purchase is desired as disclosed elsewhere herein. In one embodiment, step (b) includes charging of the thermal battery by turning on the heat pump, e.g., as shown and described in FIG. 10A. In one embodiment, step (b) includes discharging the electric battery to turn on the heat pump, e.g., as shown and described in the operating modes of FIGS. 7 and 8. In one embodiment, step (b) includes discharging the thermal battery to supplement space heating or to provide a portion of the total heat required to meet the space heating demand. In one embodiment, step (b) includes charging the electric battery if electricity purchase is desired as disclosed elsewhere herein. In one embodiment, step (c) includes charging of the thermal battery by turning on the heat pump, e.g., as shown and described in the operating modes of FIGS. 9 and 10. In one embodiment, step (c) includes discharging the electric battery to turn on the heat pump. In one embodiment, step (c) includes charging the electric battery if electricity purchase is desired as disclosed elsewhere herein.

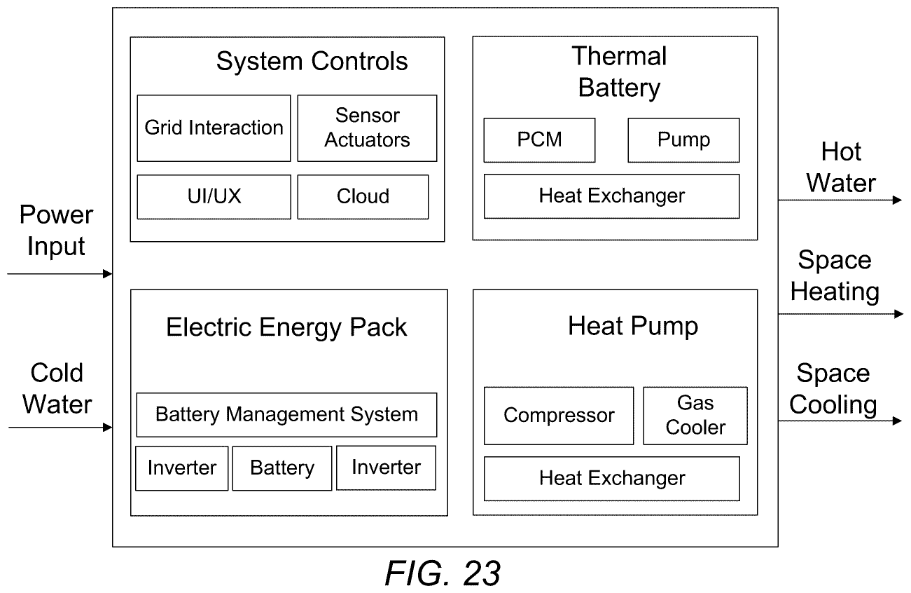

FIG. 23 is a block diagram representing distinct physical components of a synergistic system. There are four groups of physical components, i.e., the system controls group, the electric energy pack group, the thermal energy group and the heat pump group. The system controls group includes services such as the grid command controller, sensors, actuators, user interfaces and any remote or local controls and data services.

The electrical energy pack group includes a battery management system, a battery and inverters necessary to receive electrical energy from the grid and backfeed electrical energy to the grid. The thermal battery group includes a thermal storage device, e.g., PCM, a pump and a heat exchanger that facilitates charging or discharging of the thermal battery. The heat pump group includes a compressor, a space cooler and a heat exchanger which facilitates heat transfer into and out of the heat pump. The inputs are depicted on the left-hand side of the diagram while the outputs are depicted on the right hand side of the diagram. The inputs include electrical power input and unheated or cold water. The outputs are hot water, space heating and space cooling.

FIG. 24 is a block diagram representing a controller 48 of the distinct components and the connectivity of the components via the controller 48. The controller 48 is shown functionally connected to a demand forecast controller 94, a thermal battery 20, an electric battery 86, a grid command module 96, an electricity pricing module 98 and a heat pump 2. In this view, the controller 48 can be a controller responsible for all the modules functionally connected to it. However, it can also represent control systems and methods that are physically available on another controller or other controllers. The demand forecast controller 94 includes an algorithm configured to determine whether a particular action is to be carried out and when this action is to be carried out. For instance, thermal energy is stored only when there is an anticipated use that will occur in time so that the thermal energy can be transferred to a water flow in a hot water request. Thermal energy stored too early may dissipate into the surroundings of the thermal battery in which the thermal energy is stored. Regardless of the type and quality of insulation utilized to contain the thermal energy therein, losses will occur given enough time for the losses to take place. As another example, it would be more beneficial to store thermal energy in a thermal battery when the cost to do so is lower. For instance, if the total cost to supply a unit of energy at the time it is needed can be reduced by storing the energy obtained at a lower cost earlier. In the U.S., electricity pricing can be subject to fluctuations depending on the demand for electricity. As demand rises, the cost per unit electricity rises as well. As the demand for electricity increases, utility companies often generate additional capacity using less efficient equipment. Therefore, with the ability to react to this time-variant electricity pricing scheme, consumers can realize savings due not only to electricity purchase at lower costs during periods with lower demands, but also the decrease in use of less efficient power generations plants. As yet another example, it would be more beneficial to store thermal energy in a thermal battery when the difference between the outdoor temperature and the indoor temperature is more pronounced as the heat transfer rate to the thermal battery is greater. Therefore, in desert environments where the daytime temperature can soar to over 120 degrees F. and the nighttime temperature can drop to below freezing temperatures, the cost to store heat in the thermal battery is generally much lower during the day than during the night. Therefore, it may be favorable to store heat during the day for use during the night for space heating and for hot water supply. As yet another example, weather forecast may be used to anticipate a need to store thermal energy. If the outdoor temperature is expected to drop, it may be beneficial to store thermal energy for use when the outdoor temperature has dropped. As yet another example, learned usage patterns may also be used to anticipate a need to store thermal energy. If hot water is expected to be used at particular time periods of a day, components that are benefitting water heating may be prepared prior to these time periods such that if hot water is indeed requested during these time periods, the components that are configured to contribute to water heating are disposed in a state ready to heat water.

FIG. 25 is a block diagram representing a controller of additional distinct components and the connectivity of the additional distinct components via the controller 48. Here, a plurality of appliances 102, e.g., a clothes washer and a dish washer, etc., are shown connected to the controller 48. Each of the clothes washer and the dish washer includes at least a mode which requires its supply of water for washing to be hot water. Further, it is also possible to set a timer or a time to activate each of the appliances 102. The start time of a washing cycle can be communicated to a controller which in turn can be communicated to a relevant component to start preparing for the necessary hot water for the appliances 102. In one example, if heat energy is abundant during the day, the thermal battery can be used to store heat energy for use with the clothes washer or dish washer which are scheduled to turn on during the night.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A method for controlling a system comprising a heat pump, a space heater, a space cooler, a thermal battery, an electrical battery and a grid access system, said method comprising:
(a) if a hot water demand exists, turning on at least one of discharging of the thermal battery and discharging of the electric battery;
(b) if a space heating demand exists, turning on at least one of the heat pump, charging of the thermal battery, charging of the electric battery and discharging of the electric battery;
(c) if a space cooling demand exists, turning on charging of the thermal battery; and
(d) if electricity sale is desired, backfeeding electricity from the electric battery to a grid through the grid access system.

2. The method of claim 1, further comprising:
(e) if a hot water demand exists, further turning on at least one of the heat pump, charging of the thermal battery and charging of the electric battery;
(f) if a space heating demand exists, further turning on discharging of the thermal battery; and
(g) if a space cooling demand exists, further turning on at least one of the heat pump, charging of the electric battery and discharging of the electric battery.

3. The method of claim 2, wherein said step (e) comprises charging of the thermal battery by turning on the heat pump.

4. The method of claim 2, wherein said step (e) comprises charging the electric battery if electricity purchase is desired.

5. The method of claim 2, wherein said step (f) comprises discharging the thermal battery to supplement said space heating demand.

6. The method of claim 2, wherein said step (g) comprises discharging the electric battery to drive the heat pump.

7. The method of claim 2, wherein said step (g) comprises charging the electric battery if electricity purchase is desired.

8. The method of claim 1, wherein said step (a) comprises discharging the electric battery to turn on the heat pump.

9. The method of claim 1, wherein said step (a) comprises discharging of the thermal battery to supplement said hot water demand.

10. The method of claim 1, wherein said step (b) comprises charging of the thermal battery by turning on the heat pump.

11. The method of claim 1, wherein said step (b) comprises discharging the electric battery to turn on the heat pump.

12. The method of claim 1, wherein said step (b) comprises charging the electric battery if electricity purchase is desired.

13. The method of claim 1, wherein said step (c) comprises charging of the thermal battery by turning on the heat pump.
